(19) United States
(12) Patent Application Publication
(10) Pub. No.: US 2024/0230455 A1
(43) Pub. Date: Jul. 11, 2024

(54) DETERMINING A RESTRICTION IN A LIQUID NETWORK

(71) Applicant: Agilent Technologies, Inc., Santa Clara, CA (US)

(72) Inventors: Timo Witte, Waldbronn (DE); Konstantin Shoykhet, Karlsruhe (DE); Sascha Lege, Baden-Wuerttemberg (DE); Clemens Plachetka, Malsch (DE)

(21) Appl. No.: 18/562,113

(22) PCT Filed: May 16, 2022
(86) PCT No.: PCT/IB2022/054520

§ 371 Date: Nov. 17, 2023

(30) Foreign Application Priority Data
May 20, 2021 (GB) 2107242.6

(51) Int. Cl. G01M 3/26; G01N 30/32

(52) U.S. Cl. CPC G01M 3/26; G01N 30/32; G01N 2030/326

(57) ABSTRACT

A restriction in a liquid network containing a liquid is determined by generating a vacuum bubble within the liquid network, the vacuum bubble representing a volume in which the liquid has been substantially removed. A period of time between generating the vacuum bubble and until the volume has been substantially filled with the liquid is determined. A conclusion regarding the restriction is made based on the determined period of time.

### CROSS-REFERENCE TO RELATED APPLICATIONS

This application is the national stage under 35 U.S.C. 371 of International Application No. PCT/IB2022/054520, filed on May 16, 2022; which claims priority to British Application No. GB 2107242.6, filed on May 20, 2021; the entire contents of each of which are incorporated by reference herein.

### TECHNICAL FIELD

The present invention relates to determining a restriction in a liquid network, in particular in a high-performance liquid chromatography application.

### BACKGROUND

In high performance liquid chromatography (HPLC), a liquid has to be provided usually at a very controlled flow rate (e.g. in the range of microliters to milliliters per minute) and at high pressure (typically 20-100 MPa, 200-1000 bar, and beyond up to currently 200 MPa, 2000 bar) at which compressibility of the liquid becomes noticeable. For liquid separation in an HPLC system, a mobile phase comprising a sample fluid (e.g. a chemical or biological mixture) with compounds to be separated is driven through a stationary phase (such as a chromatographic column packing), thus separating different compounds of the sample fluid which may then be identified. The term compound, as used herein, shall cover compounds which might comprise one or more different components.

The mobile phase, for example a solvent, is pumped under high pressure typically through a chromatographic column containing packing medium (also referred to as packing material or stationary phase). As the sample is carried through the column by the liquid flow, the different compounds, each one having a different affinity to the packing medium, move through the column at different speeds. Those compounds having greater affinity for the stationary phase move more slowly through the column than those having less affinity, and this speed differential results in the compounds being separated from one another as they pass through the column. The stationary phase is subject to a mechanical force generated in particular by a hydraulic pump that pumps the mobile phase usually from an upstream connection of the column to a downstream connection of the column. As a result of flow, depending on the physical properties of the stationary phase and the mobile phase, a relatively high pressure drop is generated across the column.

The mobile phase with the separated compounds exits the column and passes through a detector, which registers and/or identifies the molecules, for example by spectrophotometric absorbance measurements. A two-dimensional plot of the detector measurements against elution time or volume, known as a chromatogram, may be made, and from the chromatogram the compounds may be identified.

Restrictions can be omnipresent in each liquid network, such as an HPLC system, and may adversely affect operation of or within the liquid network.

### SUMMARY

It is an object of the present disclosure to provide an improved monitoring and/or determining of a restriction in particular for HPLC applications.

According to an exemplary embodiment of the present invention, a control unit is provided for determining a restriction in a liquid network containing a liquid. The control unit is configured to invoke generating of a vacuum bubble within the liquid network, wherein the vacuum bubble represents a volume wherein the liquid has been substantially removed, determining a period of time between generating the vacuum bubble and until the volume has been substantially filled or refilled with the liquid, and concluding on the (fluidic) restriction(s) within the fluidic network based on the determined period of time. This allows to determine restrictions in a simple manner based on a time measurement.

For determining the existence of the vacuum bubble, i.e. time between generation and (re-)fill of the vacuum bubble, a sensing device (such as a pressure sensor) may be sufficient, having a lower measuring resolution for sensing a parameter of the liquid, as the accuracy as such of the measurement provided by such sensing device may be of lesser relevance. It may be sufficient to simply deriving a (qualitative) indication of the existence of the vacuum bubble, for example by determining a variation (e.g. a sudden variation) in the parameter monitored by the respective sensing device, such as a pressure drop and/or a pressure rise, without requiring a precise quantitative determination of such parameter variation. In other words, existence or disappearance of the vacuum bubble is the target of such measurement, so physical parameter(s) need/s to be assessed for abrupt change caused by such disappearance of the bubble rather than for gradual continuous changes or exact values.

In one embodiment, the vacuum bubble is substantially free of the liquid and gases, preferably except gaseous components of the liquid.

In one embodiment, generating the vacuum bubble comprises generating the vacuum bubble in a part of the liquid network coupled to one side of the restriction, while preferably the liquid network is configured to allow the liquid to flow from a part of the liquid network coupled to the opposing side of the restriction through the restriction and to fill the vacuum bubble.

In one embodiment, generating the vacuum bubble comprises abruptly increasing a volume of the liquid network, preferably faster than such increased volume is filled by the liquid. This may be done, for example by freeing a partial volume within the network (withdraw piston) or adding evacuated volume (attach evacuated reservoir, e.g. withdraw the piston in detached metering unit and then switch it into the path).

In one embodiment, generating the vacuum bubble comprises pulling a piston, preferably abruptly pulling the piston, wherein the piston motion increases a volume of the liquid network, preferably faster than such increased volume is filled by the liquid.

In one embodiment, determining the period of time comprises monitoring a value of a parameter, preferably a pressure, in the liquid, preferably in proximity to the vacuum bubble.

In one embodiment, determining the period of time comprises determining a variation of a value of a parameter, preferably a pressure, of the liquid upon generation of the vacuum bubble, and determining the period of time until the parameter has substantially reached a value before generation of the vacuum bubble.

In one embodiment, the period of time is determined between a first point in time when a value of a parameter, preferably a pressure, varies caused upon generation of the vacuum bubble, and a second point in time when the value of the parameter of the liquid has substantially reached a value before generation of the vacuum bubble.

In one embodiment, the period of time is determined between a first point in time, when the action, preferably the piston withdrawal, was invoked or executed to generate the vacuum bubble, and a second point in time when the value of the parameter of the liquid has substantially reached a value before generation of the vacuum bubble.

In one embodiment, the period of time is determined between a first point in time and a second point in time, whereas at least one of the said points is characterized by rapid change of the value of the parameter of the liquid. Such rapid change can be determined by exceeding of a pre-set or dynamically determined threshold value by the time derivative of the said parameter.

In one embodiment, the said rapid change of a parameter value can be determined by known peak detector algorithms applied to the said parameter value or its derivative over time.

In one embodiment, the period of time is determined between a first point in time when an underpressure in the liquid occurs upon generation of the vacuum bubble, and a second point in time when the underpressure has substantially been removed or equilibrated.

In one embodiment, the parameter is at least one of: a pressure, a flow, preferably a flow rate, a density, a temperature, a force acting on a piston having generated the vacuum bubble, and any kind of parameter suitable to determine whether there is at least one of a pressure difference or a flow over the restriction.

In one embodiment, the parameter is at least one of: an electric conductivity of the liquid, at least in the area of the vacuum bubble; an electric capacity of the liquid at least in the area of the vacuum bubble; velocity of sound propagation at least in the area of the vacuum bubble, et cetera.

In one embodiment, concluding on the restriction comprises determining a value of restriction representing a quantitative value of the restriction in the liquid network.

In one embodiment, concluding on the restriction comprises determining a qualitative information, e.g. whether the restriction has increased or decreased, preferably by comparing with a reference, preferably previously determined for the restriction. Such qualitative information may simply be whether there is a restriction or not, or whether a known (for example previously determined) restriction has increased or decreased, for example irrespective on a precise quantitative value of flow resistance provided by the restriction.

In one embodiment, the liquid network is configured so that upon generation of the vacuum bubble, liquid from within the liquid network can flow through the restriction, and liquid from within the liquid network can flow to fill the vacuum bubble.

In one embodiment, the liquid network is configured so that on one side of the restriction the vacuum bubble can be generated, while upon generation of the vacuum bubble liquid can flow from an opposing side of the restriction through the restriction.

In one embodiment, the liquid network is configured so that on one side of the restriction the vacuum bubble can be generated, while upon generation of the vacuum bubble a pressure of the liquid on the opposing side of the restriction is higher than a pressure of the liquid where the vacuum bubble has been generated.

One embodiment of the present invention provides a liquid supply path comprising a liquid network containing a liquid and having a liquid drive, preferably a pumping system, configured for supplying the liquid at an outlet of the liquid network, and a control unit, according to any one of the aforedescribed embodiments, configured for determining a restriction in the liquid network.

In one embodiment, the control unit is configured for providing a blockage, so that a flow rate at the outlet (of the liquid network) is substantially zero.

In one embodiment, the liquid network is configured to have multiple fluidic connections to the part of the network comprising the vacuum bubble, whereas at least one of the connections might be prone to restriction changes or artifacts.

In one embodiment, the liquid network is configured to have multiple fluidic connections to the part of the network comprising the vacuum bubble, whereas at least one of the connections has fluidic resistance to an inlet or an outlet significantly differing from that of one another connection.

In one embodiment, the liquid network is configured to have multiple fluidic connections to the part of the network comprising the vacuum bubble, whereas at least one of the connections comprises fluidic elements enabling preferably only uni-directional motion of the liquid, such as check valves.

In one embodiment, the control unit is configured for controlling the liquid drive to generate the vacuum bubble.

One embodiment comprises a sensor configured for determining a value of a parameter of the liquid, preferably for determining a value of pressure of the liquid.

One embodiment comprises a source comprising the liquid.

In one embodiment, a fluid separation system is provided for separating compounds of a sample fluid in a mobile phase. The fluid separation system comprises a liquid supply path according to any one of the aforedescribed embodiments, wherein the liquid is the mobile phase and the liquid drive is a mobile phase drive, preferably a pumping system, adapted to drive the mobile phase through the fluid separation system, and a separation unit, preferably a chromatographic column, adapted for separating compounds of the sample fluid in the mobile phase.

The fluid separation system may further comprise one or more of: a sample dispatcher adapted to introduce the sample fluid into the mobile phase; a detector adapted to detect separated compounds of the sample fluid; a collection unit adapted to collect separated compounds of the sample fluid; a data processing unit adapted to process data received from the fluid separation system; and a degassing apparatus for degassing the mobile phase.

One embodiment provides a method for determining a restriction in a liquid network containing a liquid. The method comprises generating a vacuum bubble within the liquid network, wherein the vacuum bubble representing a volume wherein the liquid has been substantially removed, determining a period of time between generating the vacuum bubble and until the volume has been substantially (re-)filled with the liquid, and concluding on the restriction based on the determined period of time.

Embodiments of the present invention might be embodied based on most conventionally available HPLC systems, such as the Agilent 1220, 1260 and 1290 Infinity LC Series (provided by the applicant Agilent Technologies).

One embodiment of an HPLC system comprises a pumping apparatus having a piston for reciprocation in a pump working chamber to compress liquid in the pump working chamber to a high pressure at which compressibility of the liquid becomes noticeable.

One embodiment of an HPLC system comprises two pumping apparatuses coupled either in a serial or parallel manner. In the serial manner, as disclosed in EP 309596 A1, an outlet of the first pumping apparatus is coupled to an inlet of the second pumping apparatus, and an outlet of the second pumping apparatus provides an outlet of the pump. In the parallel manner, an inlet of the first pumping apparatus is coupled to an inlet of the second pumping apparatus, and an outlet of the first pumping apparatus is coupled to an outlet of the second pumping apparatus, thus providing an outlet of the pump. In either case, a liquid outlet of the first pumping apparatus is phase shifted, preferably essentially by 180 degrees, with respect to a liquid outlet of the second pumping apparatus, so that only one pumping apparatus is supplying into the system while the other is intaking liquid (e.g. from the supply), thus allowing to provide a continuous flow at the output. However, it is clear that also both pumping apparatuses might be operated in parallel (i.e. concurrently), at least during certain transitional phases e.g. to provide a smooth(er) transition of the pumping cycles between the pumping apparatuses. The phase shifting might be varied in order to compensate pulsation in the flow of liquid as resulting from the compressibility of the liquid. It is also known to use three piston pumps having about 120 degrees phase shift. Also other types of pumps are known and operable in conjunction with the present invention.

One embodiment of an HPLC system comprises a sample introduction device, comprising a metering device in form of a syringe or piston capable of displacement motion in a reservoir or cylinder. In the embodiment, the aforementioned vacuum bubble generation may be accomplished by the said metering device.

The separating device preferably comprises a chromatographic column providing the stationary phase. The column might be a glass, metal, ceramic or a composite material tube (e.g. with a diameter from 50 μm to 5 mm and a length of 1 cm to 1 m) or a microfluidic column (as disclosed e.g. in EP 1577012 A1 or the Agilent 1200 Series HPLC-Chip/MS System provided by the applicant Agilent Technologies. The individual components are retained by the stationary phase differently and separate from each other while they are propagating at different speeds through the column with the eluent. At the end of the column they elute at least partly separated from each other. During the entire chromatography process the eluent might be also collected in a series of fractions. The stationary phase or adsorbent in column chromatography usually is a solid material. The most common stationary phase for column chromatography is silica gel, followed by alumina. Cellulose powder has often been used in the past. Also possible are ion exchange chromatography, reversed-phase chromatography (RP), affinity chromatography or expanded bed adsorption (EBA). The stationary phases are usually finely ground powders or gels and/or are microporous for an increased surface, which can be especially chemically modified, though in EBA a fluidized bed is used.

The mobile phase (or eluent) can be either a pure solvent or a mixture of different solvents. It can also contain additives, i.e. be a solution of the said additives in a solvent or a mixture of solvents. It can be chosen e.g. to adjust the retention of the compounds of interest and/or the amount of mobile phase to run the chromatography. The mobile phase can also be chosen so that the different compounds can be separated effectively. The mobile phase might comprise an organic solvent like e.g. methanol or acetonitrile, often diluted with water. For gradient operation water and organic is delivered in separate containers, from which the gradient pump delivers a programmed blend to the system. Other commonly used solvents may be isopropanol, THF, hexane, ethanol and/or any combination thereof or any combination of these with aforementioned solvents.

The sample fluid might comprise any type of process liquid, natural sample like juice, body fluids like plasma or it may be the result of a reaction like from a fermentation broth.

The fluid is preferably a liquid but may also be or comprise a gas and/or a supercritical fluid (as e.g. used in supercritical fluid chromatography—SFC—as disclosed e.g. in U.S. Pat. No. 4,982,597 A).

The pressure in the mobile phase might range from 2-200 MPa (20 to 2000 bar), in particular 10-150 MPa (100 to 1500 bar), and more particular 50-120 MPa (500 to 1200 bar).

The HPLC system might further comprise a detector for detecting separated compounds of the sample fluid, a fractionating unit for outputting separated compounds of the sample fluid, or any combination thereof. Further details of HPLC system are disclosed with respect to the aforementioned Agilent HPLC series, provided by the applicant Agilent Technologies.

Embodiments of the invention can be partly or entirely embodied or supported by one or more suitable software programs or products (or software), which can be stored on or otherwise provided by any kind of non-transitory medium or data carrier, and which might be executed in or by any suitable data processing unit such as an electronic processor-based computing device (or system controller, control unit, etc.) that includes one or more electronic processors and memories. Software programs or routines (e.g., computer-executable or machine-executable instructions or code) can be preferably applied in or by the control unit, e.g. a data processing system such as a computer, such as for executing any of the methods described herein. For example, one embodiment of the present disclosure provides a non-transitory computer-readable medium that includes instructions stored thereon, such that when executed on a processor, the instructions perform the steps of the method of any of the embodiments disclosed herein.

In the context of this application, the term “liquid network” may particularly denote a plurality of fluidic elements fluidically coupled with each other.

In the context of this application, the term “fluidic element” may cover any kind of element at least temporarily allowing a flow of the liquid, such as a conduit, a filter, a valve, a column, a pump, et cetera.

In the context of this application, the term “fluidically coupled” may cover any coupling between two or more fluidic elements allowing at least temporarily a flow of the liquid.

In the context of this application, the term “restriction” may particularly denote a (fluidic) flow resistance against a forced flow of a liquid, for example against a forced flow into a given flow direction. The term “restriction” may cover static restrictions (which may result e.g. from finite dimensions in particular of fluid conduits and other elements in the flow path), dynamic restrictions (which may result from actual flow conditions, such as a specific viscosity resulting from a solvent composition e.g. during a gradient mode), and/or operation-caused restrictions (which may result from and vary during operation of the liquid network, for example from accumulating particles). Accordingly, any kind of fluidic element within the liquid network and/or a part of the liquid network comprising plural fluidic elements of the liquid network may represent such “restriction”. The term “restriction” may particularly be understood as a flow resistance between one side of a respective fluidic element and an opposing side of the respective fluidic element, so that the restriction is provided between these sides of the fluidic element, wherein the term “side” shall mean an entry point of liquid into and/or an exit point of liquid from the fluidic element, such as a terminal of such fluidic element. Accordingly, a fluidic element having more than two sides may provide plural different restrictions each between different sides. While every fluidic element has a non-zero flow resistance, the term “restriction” may in particular cover a respective fluidic element having a value of flow resistance beyond a certain threshold value (of flow resistance), so that the flow resistance may become noticeable within the fluidic network. For example, a fluidic element before clogging may have a low flow resistance below a certain threshold and accordingly not be considered as a restriction within the fluidic network, while the fluidic element after clogging may have a high flow resistance higher than or equal to the threshold and be considered as a restriction within the fluidic network. Alternatively or in addition, the term restriction may also cover fluidic characteristics such as tightness or leakage.

Restrictions may occur in a deterministic manner and/or result from unwanted or undesired behavior (such as accumulating particles) of or within the system such as the fluidic network. Restrictions may be constant or vary over time (e.g. during the course of operation), e.g. in the sense that a value of flow resistance of a restriction varies over the time and/or that a restriction is noticeable or not and/or that a restriction occurs or disappears. For example, particles may accumulate at a certain position within the liquid network thus leading to an operation-caused restriction, with a value of flow resistance of such operation-course restriction increasing over time, for example with an increasing amount of accumulating particles, which may eventually even lead to a full blockage.

In the context of this application, the term “vacuum bubble” or “vacuum cavity” may particularly denote a volume in a liquid network wherein the liquid has been substantially removed. The vacuum bubble may be substantially free of the liquid and/or gases, preferably except gaseous components of the liquid. A vacuum bubble may be generated for example by abruptly increasing a volume of the liquid network, preferably faster than such increased volume can be filled or refilled by the liquid, for example by abruptly pulling a piston for increasing the volume of the liquid network. Additionally or alternatively such vacuum bubble can be generated by one of connecting an evacuated reservoir to the liquid network or abrupt cool down of a location in a liquid network, filled with a solvent vapor, e.g. previously generated by abrupt local heating of a part of the liquid network over the boiling temperature of the comprised liquid.

In the context of this application, the term “fluidic sample” may particularly denote any liquid and/or gaseous medium, optionally including also solid particles, which is to be analyzed. Such a fluidic sample may comprise a plurality of fractions of molecules or particles which shall be separated, for instance biomolecules such as proteins. Since separation of a fluidic sample into fractions involves a certain separation criterion (such as mass, volume, chemical properties, etc.) according to which a separation is carried out, each separated fraction may be further separated by another separation criterion (such as mass, volume, chemical properties, etc.), thereby splitting up or separating a separate fraction into a plurality of sub-fractions.

In the context of this application, the term “downstream” may particularly denote that a fluidic member located downstream compared to another fluidic member will only be brought in interaction with a fluidic sample or its components after interaction of those with the other fluidic member (hence being arranged upstream). Therefore, the terms “downstream” and “upstream” relate to a general flowing direction of the fluidic sample or its components, but do not necessarily imply a direct uninterrupted fluidic connection from the upstream to the downstream system parts.

In the context of this application, the term “sample separation apparatus” may particularly denote any apparatus which is capable of separating different fractions of a fluidic sample by applying a certain separation technique. Particularly, two separation units may be provided in such a sample separation apparatus when being configured for a two-dimensional separation. This means that the sample or any of its parts or subset(s) is first separated in accordance with a first separation criterion, and is subsequently separated in accordance with a second separation criterion, which may be the same or different.

The term “separation unit” may particularly denote a fluidic member through which a fluidic sample is guided and which is configured so that, upon conducting the fluidic sample through the separation unit, the fluidic sample or some of its components will be at least partially separated into different groups of molecules or particles (called fractions or sub-fractions, respectively) according to a certain selection criterion. An example for a separation unit is a liquid chromatography column which is capable of selectively retarding different fractions of the fluidic sample.

In the context of this application, the terms “fluid drive” or “mobile phase drive” may particularly denote any kind of pump or fluid flow source or supply which is configured for conducting a mobile phase and/or a fluidic sample along a fluidic path. A corresponding fluid supply system may be configured for metering two or more fluids in controlled proportions and for supplying a resultant mixture as a mobile phase. It is possible to provide a plurality of solvent supply lines, each fluidically connected with a respective reservoir containing a respective fluid, a proportioning appliance interposed between the solvent supply lines and the inlet of the fluid drive, the proportioning appliance configured for modulating solvent composition by sequentially coupling selected ones of the solvent supply lines with the inlet of the fluid drive, wherein the fluid drive is configured for taking in fluids from the selected solvent supply lines and for supplying a mixture of the fluids at its outlet. More particularly, one fluid drive can be configured to provide a mobile phase flow which drives or carries the fluidic sample through a respective separation unit, whereas another fluid drive can be configured to provide a further mobile phase flow which drives or carries the fluidic sample or its parts after treatment by respective separation unit, through a further separation unit.

Embodiments of the present invention provide a method for verification and qualification of the solvent intake and delivery path in a liquid chromatograph, e.g. a liquid chromatograph with verification/validation of the solvent intake and delivery path. Prior art methods are typically based on use of additional pressure or flow sensors and are thus more expensive in implementation. According to an embodiment, an evacuated cavity (such as a vacuum bubble) is generated within a flow path, and pressure in the flow path is monitored. Duration of an interval with lowered pressure readings shows how long it takes for the solvent to fill the cavity and thus can be indicative for the flow resistance along the fluidic path. This allows providing a method (not requiring additional equipment or sensors) to check for clogging of the parts of the flow path and e.g. to check the sealing of the low-pressure valves in the flow path. Typically, the restriction check on parts of the flow path are only run during Operational Qualification and/or Performance Verification (OQ-PV) procedures or triggered by performance deterioration of the instrument. Embodiment of the present invention can provide an easy automatable procedure for instrument health verification and diagnosis.

Embodiments of the present invention can help to detect restrictions and track the change of restrictions in liquid chromatographic (LC) pumps in the flow path of LC systems and to verify the tightness of the flow path in specific configurations.

Operation of an LC instrument typically relies on availability of unconstrained intake of operation fluids from one or more respective liquid reservoirs, primarily of the solvents or eluents from one or more solvent bottles or of the sample e.g. from one or more sample vials. However, it is not uncommon that e.g. a tubing, filter or other flow part component may get obstructed or clogged. This can lead to detrimental effects e.g. on the chromatographic performance of the instrument, especially if such obstructions occur in the intake or suction parts of the flow path (for example upstream to an inlet of the high-pressure chromatographic pump), in particular where the atmospheric pressure may be the only available moving force for the liquid (optionally supported by a small hydrostatic pressure of the solvent in the tubes, for example if the bottles are standing on or above the instrument). Such failures are typically difficult to diagnose, usually the respective parts of the system are not equipped with sensors, especially in the low budget segment.

Embodiments of the present invention provide an automated procedure for checking the freedom of flow in the relevant parts of the flow path, such as intake lines or sample intake tubing (as the sample is also intaken into the instrument by suction).

For optimal operation of certain pump schemata, it can also be important that there is no obstruction for the flow between the cylinders of the pump.

Another vulnerable sub-unit on the LC pump can be the so-called proportioning valve, which selectively connects the solvent intake lines in turn one after another to the pump during an intake, in order to generate a desired mixing ratio of the solvents in the mixture. If one of the lines of such proportioning valve does not close tightly, the generated mixture composition can be biased or even air bubbles can be sucked in from an unused line. Embodiments of the present invention can provide a rapid and precise procedure for such check.

In one embodiment of an HPLC system, a primary piston remains in a min-volume position, a secondary piston starts in the min-volume position, and a (preferably multi-purpose) valve is in a block position (e.g. blocking or closing an outlet of the pump). Pressure can be monitored e.g. at a pressure sensor. The secondary piston of the pump is rapidly moved backward to create a “vacuum” inside the secondary pump head, thus creating a “vacuum cavity” or “vacuum bubble” in the secondary pump head. The vacuum draws in new solvent through the path which leads back to the solvent bottle, atmospheric pressure may push in new solvent into the secondary pump at. At some time the vacuum cavity can be filled completely, and the pressure inside the secondary pump head (and e.g. at the pressure sensor) returns back e.g. to atmospheric pressure. The time which passes during the first pressure drop, when the piston movement is started, and the point in time where the pressure returns back to atmospheric can be (e.g. directly) proportional to the restriction present in the path (e.g. between the solvent bottle and the secondary pump head) and/or, for example, to the viscosity of the solvent in the lines. With the volume removed being known as well as an (expected) solvent viscosity, the restriction can be determined and/or calculated, and a functional condition of the system can be verified.

In embodiments of the present invention, it is possible to generate an evacuated cavity (i.e. a “vacuum cavity” or “vacuum bubble”) at any location in the system, preferably where a reciprocating piston is installed. This can be achieved by rapid or abrupt retreat of the respective piston. Once such cavity is created, it is possible to monitor its existence, i.e. assess time needed for the solvent to re-flood the cavity, e.g. by monitoring the readings of a pressure sensor located anywhere in the flow path (but preferably not immediately at the intake terminal). Specifically, the nearly constant reduced pressure readings can persist as long as the vacuum cavity exists, and the refilling flow is present. At the moment the cavity is re-flooded, the pressure readings can abruptly return e.g. to initial values. Thus, the re-flooding time can be indicative for the flow path condition and thus of the restriction provided in or by the flow path.

In embodiments, to enable the tests described, the purge valve of the pump or the injection valve in the sampler or the column selection valve can be driven into a diagnostic position, blocking the downstream part of the flow path. Alternatively, the needle of the autosampler can be driven to “blind seat” or plug, thus blocking the downstream part of the flow path.

In embodiments, to facilitate these operation modes the inlet valve of the pump is set to be open. If the pump is equipped with a passive inlet valve (PIV) it will open by itself, if there is an active inlet valve—it may be needed to be opened by pump controller. Apparently, a known failure mode of PIV—stuck valve (not opening) can be readily recognized by the procedure, because the pressure will “never” be restored (will take a very long time).

In embodiments, the system pressure sensor located at the pump outlet can be utilized for pressure monitoring, though other pressure or flow sensors or gauges, if present, can also be used or even be advantageous.

In embodiments, it is possible to check the condition of the intake line, comprising a vulnerable element such as an inlet filter. Moreover, practically the maximum achievable intake flow can be even more relevant for the pump operation than the flow path restriction itself, and the proposed methods may provide the value of the maximum intake flow directly, once the vacuum cavity is generated e.g. in a primary piston of a series-cylinder LC pump (also known as 1.5 cylinder pump). Practically, the value measured in such procedure (volume of the primary piston abrupt retreat divided by the respective refill time) can be reduced by a safety factor, e.g. 2, in order to generate only moderate sucking pressure of e.g. 500 mBar below atmospheric, and to avoid occasional outgasing of the solvents during intake. In order to enable this operation mode, the pressure sensor may be kept fluidically connected to the primary cylinder. The passive outlet check valve (OV) might decouple the pressure sensor from the primary cylinder, if the pressure in the primary cylinder is lower than in the secondary. It may not be very probable, because the micro-leakages in the OV at low pressures would decrease the pressure in the secondary cylinder and associated part of the flow path, including pressure sensor. Still it is possible to enforce the OV to open by retreating the secondary piston by a small volume sufficient just to generate lowered pressure on the pressure sensor (the value of pressure on the pressure sensor would only abruptly restore after the cavity in the primary cylinder is filled and the solvent would fill up the rest of the path up to the regular pressure level). Alternatively, the secondary piston can be retreated continuously and either slowly or abruptly; the time needed to refill the intake volume in the secondary cylinder should be also considered. This test mode can be utilized for individual checking the reliable and sufficient opening of the channels of a proportioning valve.

In embodiments, it is possible to assess the flow resistance for the fluid to enter the secondary cylinder (starting from the intake line). In this case the secondary piston would retreat, and the system pressure sensor would be monitored.

In embodiments, using the delta from assessing the flow resistance for the fluid to enter the primary and the secondary cylinder, e.g. as outlined above, it is possible to calculate the restriction of the path between the primary and secondary piston. This may be a heat exchanger.

In embodiments, it is also possible to check the flow restriction from the inlet to the autosampler's metering device, if the vacuum cavity is generated by retreat of the sampler's metering piston and the flow path is blocked downstream of that (needle to blind seat, diagnostic position of the injection valve or of the column selection valve). This test may, however, be less relevant and less reliable, because the relevant information can be gained by pumping liquid by the pump to sampler needle in the waste position, and because otherwise sucking the liquid through a long line of thin capillaries and filters between the pump and the sampler can be influenced by strong surface tension effects, if vacuum bubbles appear in the capillaries or filters.

In embodiments, another relevant check can be determining the maximum intake flow rate for the sample. For this the part of the flow path containing the injection needle and the system (or other) pressure sensor is isolated. This can be achieved at different locations, e.g. by closure of all channels of a proportioning valve, by closure of an active inlet valve, or in a diagnostic position of the pump's purge valve.

Depending on where the flow path is interrupted, any of the pistons (pumps primary, or secondary, but preferably the metering piston of the autosampler) can be retreated to generate a vacuum cavity and thus a vacuum bubble. The sampler needle can be immersed into a liquid, preferably having the viscosity of the sample, once large sample volumes are envisioned. The time needed to re-flood the vacuum cavity can be indicative for the maximum achievable sample intake speed. The most relevant and direct result can be achieved by retreating the metering device piston.

In embodiments, a test mode is verification of tightness of the flow path, which is supposed to be closed.

In embodiments, a use case is verification of reliable closure of the channels of a proportioning valve, such as a multichannel gradient valve (MCGV). For that, all channels of a proportioning valve should be closed, and the flow path blocked flow downstream of the primary cylinder of the pump, e.g. as described above. A vacuum cavity might be generated somewhere in the blocked section of the flow path containing a pressure sensor between the proportioning valve and the second block location. The tightness can be proved once the decreased pressure is maintained over a long time, especially if the generated cavity has a small volume. Alternatively, after certain time is elapsed, the piston can be cautiously moved forwards and the piston position, at which the pressure begins to increase can be noted. In this case the difference of the initial (before retreat) and final positions can be indicative for the amount of solvent, leaked into the flow path.

Embodiments of the present invention allow monitoring pressure drops at the parts of the flow path, preferably relying on monitoring of steep pressure change events of nearly 1 bar magnitude. These can be easily detectable even with comparably “noisy” pressure sensors (such as high pressure sensors with maximum pressure of several 100 or even 1000 bar and above, used as system pressure sensors), whereas measurement of minute pressure values within 1 bar range may be difficult or even impossible with such sensors.

Embodiments of the present invention allow monitoring flow start/stop events rather than pressure change events (e.g. by flow sensors) within the relevant parts of the flow path.

### BRIEF DESCRIPTION OF DRAWINGS

Other objects and many of the attendant advantages of embodiments of the present invention will be readily appreciated and become better understood by reference to the following more detailed description of embodiments in connection with the accompanied drawing(s). Features that are substantially or functionally equal or similar will be referred to by the same reference sign(s). The illustration in the drawing is schematic.

FIG. 1 shows a liquid separation system 10, in accordance with embodiments of the present invention, e.g. used in high performance liquid chromatography (HPLC).

FIG. 2 schematically illustrates an embodiment for determining a restriction in a liquid network 200.

FIG. 3 shows an example of a measurement plot provided by the pressure sensor 240 in the arrangement of FIG. 2.

FIG. 4 illustrates in an example a repeated restriction testing in the liquid network 200.

FIG. 5 illustrates an exemplary embodiment of the liquid network 200.

FIG. 6 describes another embodiment and examples for detection of restrictions.

### DETAILED DESCRIPTION

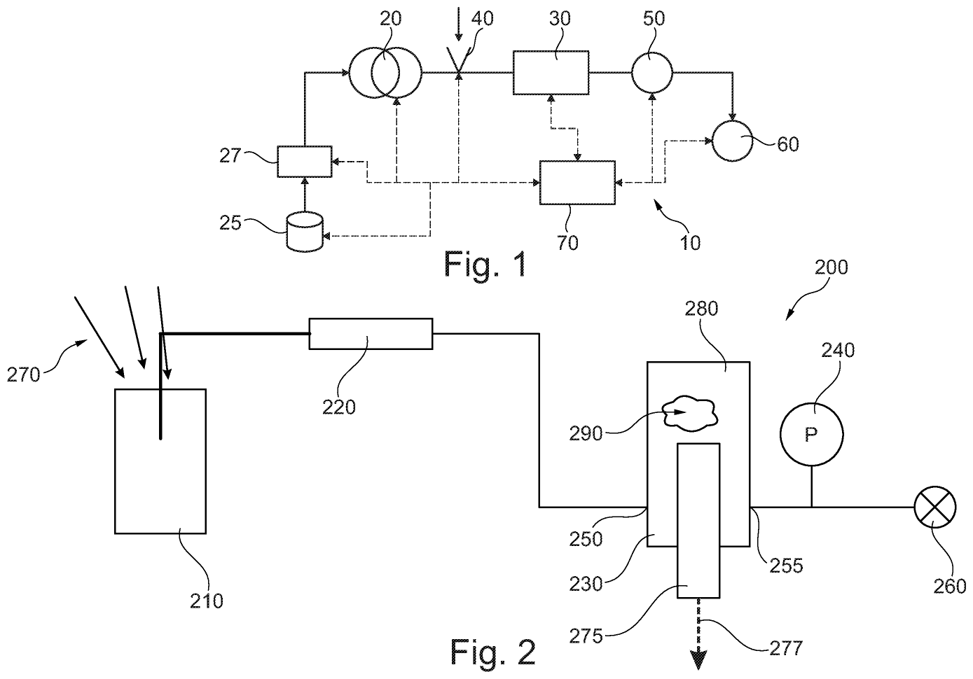

Referring now in greater detail to the drawings, FIG. 1 depicts a general schematic of a liquid separation system 10. A pump 20 receives a mobile phase from a solvent supply 25, typically via a degasser 27, which degases the mobile phase and thus reduces the amount of dissolved gases in it. The pump 20—as a mobile phase drive—drives the mobile phase through a separating device 30 (such as a chromatographic column) comprising a stationary phase. A sample dispatcher 40 (also referred to as sample introduction apparatus, sample injector, etc.) is provided between the pump 20 and the separating device 30 in order to subject or add (often referred to as sample introduction) portions of one or more sample fluids into the flow of a mobile phase (denoted by reference numeral 200, see also FIG. 2). The stationary phase of the separating device 30 is adapted for separating compounds of the sample fluid, e.g. a liquid. A detector 50 is provided for detecting separated compounds of the sample fluid. A fractionating unit 60 can be provided for outputting separated compounds of sample fluid.

While the mobile phase can be comprised of one solvent only, it may also be mixed of plurality of solvents. Such mixing might be a low pressure mixing and provided upstream of the pump 20, so that the pump 20 already receives and pumps the mixed solvents as the mobile phase. Alternatively, the pump 20 might be comprised of plural individual pumping units, with plural of the pumping units each receiving and pumping a different solvent or mixture, so that the mixing of the mobile phase (as received by the separating device 30) occurs at high pressure und downstream of the pump 20 (or as part thereof). The composition (mixture) of the mobile phase may be kept constant over time, the so-called isocratic mode, or varied over time, the so-called gradient mode.

A data processing unit 70, which can be a conventional PC or workstation, might be coupled (as indicated by the dotted arrows) to one or more of the devices in the liquid separation system 10 in order to receive information and/or control operation. For example, the data processing unit 70 might control operation of the pump 20 (e.g. setting control parameters) and receive therefrom information regarding the actual working conditions (such as output pressure, flow rate, etc. at an outlet of the pump). The data processing unit 70 might also control operation of the solvent supply 25 (e.g. monitoring the level or amount of the solvent available) and/or the degasser 27 (e.g. setting control parameters such as vacuum level) and might receive therefrom information regarding the actual working conditions (such as solvent composition supplied over time, flow rate, vacuum level, etc.). The data processing unit 70 might further control operation of the sample dispatcher 40 (e.g. controlling sample introduction or synchronization of the sample introduction with operating conditions of the pump 20). The separating device 30 might also be controlled by the data processing unit 70 (e.g. selecting a specific flow path or column, setting operation temperature, etc.), and send—in return—information (e.g. operating conditions) to the data processing unit 70. Accordingly, the detector 50 might be controlled by the data processing unit 70 (e.g. with respect to spectral or wavelength settings, setting time constants, start/stop data acquisition), and send information (e.g. about the detected sample compounds) to the data processing unit 70. The data processing unit 70 might also control operation of the fractionating unit 60 (e.g. in conjunction with data received from the detector 50) and provides data back. Finally the data processing unit might also process the data received from the system or its part and evaluate it in order to represent it in adequate form prepared for further interpretation.

The liquid separation system 10 as depicted in FIG. 1 represents an exemplary embodiment of a liquid network comprising a plurality of fluidic elements. In such liquid network, one or more restrictions may be present or occur during or caused by operation. For example, a filter, tubing, or other conduit may get obstructed or clogged, e.g. resulting from particles in the liquid, such as solid particle, and represent such restriction in the liquid network. Other examples of restrictions can be: mechanical deformation (capillaries, fittings), alteration in construction materials, such as swelling (plastic parts, switching valve components), wear of the parts of the network resulting in changes of the mechanical dimensions of the liquid channels (groove flattening in the rotary valves due to wear), but also portions of undesired or unexpectedly viscous liquid in the liquid network, permanent or temporary damage to check valves preventing their opening, biofilms due to microorganisms growing especially on solvent intake filters in the bottles, et cetera.

Restrictions can be or occur (e.g. during operation) at any position within the liquid network. In many liquid networks, restrictions are more critical at lower pressure than under high pressure operations. In particular, restrictions occurring at an intake path (i.e. upstream) to a pump may be more critical than downstream to such pump.

In the liquid separation system 10 schematically represented in FIG. 1, restrictions in the intake path upstream to the pump 20 may influence solvent composition (i.e. a mixture of plural different solvents) and may thus adversely affect accuracy of the chromatographic separation. Restrictions downstream to the pump 20, on the other hand, may be compensated by the pump 20 itself and may thus be considered less critical than restrictions upstream to the pump 20. Accordingly, embodiments given in the following to determine restrictions shall be provided with respect to restrictions upstream to the pump 20. However, it is clear that the principles on how to determine restrictions apply accordingly and to any position within the liquid network such as the liquid separation system 10.

FIG. 2 schematically illustrates an embodiment for determining a restriction in a liquid network 200 which may be the part of the liquid separation system 10 upstream to and including the pump 20, as shown in FIG. 1. The liquid network 200 comprises a liquid reservoir 210 (which may be the solvent supply 25), a fluidic element 220 (which may be a filter), a pumping unit 230 (which may be the pump 20), and a pressure sensor 240, which are all fluidically coupled with each other by respective conduits. The fluidic element 220 is fluidically coupled between the liquid network 200 and an inlet 250 of the pumping unit 230. An outlet 255 of the pumping unit 230 is coupled to a blockage 260 allowing to close a flow of the liquid in the liquid network 200. The pressure sensor 240 can be at any position within the liquid network 200 and is exemplary shown coupled between the outlet 255 and the blockage 260.

The liquid reservoir 210 may be substantially at atmospheric pressure, for example by having an opening against ambient (as indicated by arrows 270).

The pumping unit 230 has a piston 275 which may be moved or reciprocated (indicated by the arrow 277) within a pumping chamber 280. With the pumping chamber 280 opening on either side (with the inlet 250 and the outlet 255) into the liquid network 200, the pumping chamber 280 as well as the entire liquid network 200 is filled with a liquid which may be received (e.g. drawn) from the liquid reservoir 210.

Operation of the pumping unit 230, in particular movement of the piston 275, is controlled by a (non-shown) control unit which may be the control unit 70 of FIG. 1. The control unit 70 may also control and/or read out the pressure sensor 240 thus allowing to determine a value of pressure of the liquid in the liquid network 200. The control unit 70 may also control the blockage 260 in the sense of either closing the flow path or opening the flow path beyond the blockage 260 (not further illustrated here).

In an equilibrated state, the pressure of the liquid is the same everywhere within the liquid network 200. In the example shown here with the liquid reservoir 210 being open to ambient, the pressure of the liquid in the liquid network 200 shall be substantially at atmospheric pressure.

In a state of operation of the liquid network 200 (not further detailed here), the blockage 260 is removed, thus allowing a flow of the liquid beyond the blockage 260. With the liquid network 200 comprising adequate valving means, for example a (not shown) inlet valve at the inlet 250 and/or a (not shown) outlet valve at the outlet 255, reciprocating the piston 275 in the pumping chamber 280 allows to draw liquid from the liquid reservoir 210 and supply pressurised liquid beyond the blockage 260.

The fluidic element 220 may be a filter which over the time may be subject to clogging, e.g. resulting from particles within the liquid which may accumulate in the filter 220, so that the fluidic element 220 over the time may represent a restriction in the liquid network 200. Such restriction may adversely affect operation of the liquid network 200, for example by limiting the amount of liquid drawn into the pumping chamber 280. In particular when solvents from plural liquid reservoirs 210, each containing a different solvent, shall be drawn in, mixed, and supplied by the pumping units 230, such restriction may affect accuracy of the mixing.

For determining whether there is a restriction in the liquid network 200, the control unit 70 controls the piston 275 to be abruptly pulled in the direction of the arrow 277, thus generating a vacuum bubble 290 in the pumping chamber 280. The vacuum bubble 290 represents a volume substantially without liquid and gases. The vacuum bubble 290 results from abruptly increasing a volume of the liquid network 200 in a way faster than the liquid of the liquid network can fill or refill such increased volume. In other words, when the piston 275 increases the volume of the liquid network 200 faster than liquid (from the liquid network 200) can flow into and (re-)fill such increased volume, the increased volume represents the vacuum bubble 290 as a volume being substantially free of liquid and gases.

Under normal conditions, the liquid network 200 will “counteract” in order to fill and remove the vacuum bubble 290. The time required for such counteracting, however, depends on the flow conditions within the liquid network 200, in particular on a flow resistance (and maybe the existence of a restriction) in the liquid network 200, as the restriction may represent an (e.g. an unacceptable) high value of flow resistance in the liquid network 200. This allows to use the time period required for such counteracting as a measure for the restriction, as will be illustrated in more detail in the following.

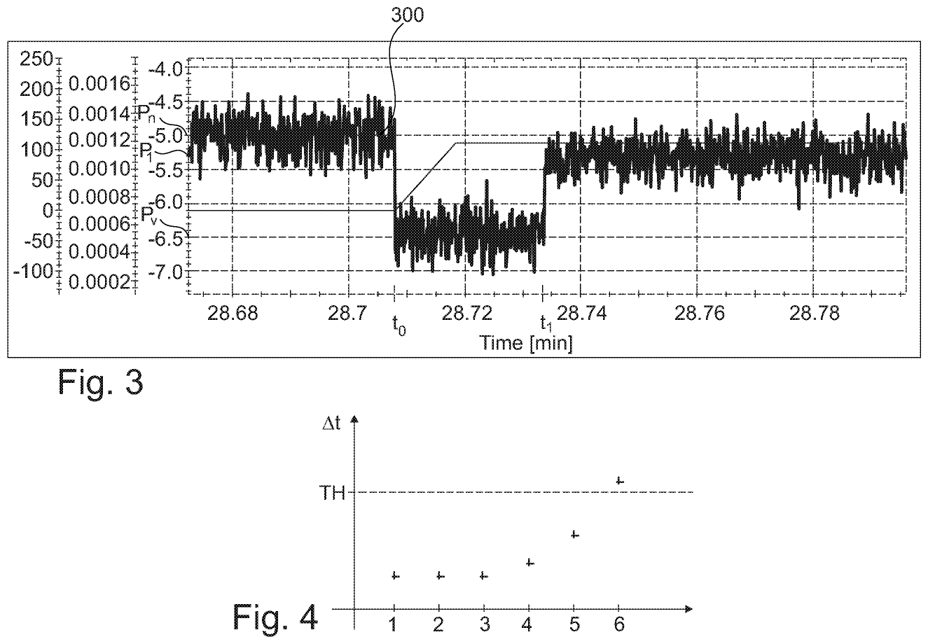

FIG. 3 shows an example of a measurement plot provided e.g. by the pressure sensor 240 in the arrangement of FIG. 2. Graph 300 shows the course of pressure (ordinate) over time (abscissa). At a point in time to, the piston 275 is abruptly pulled (in the direction of the arrow 277 in FIG. 2), thus generating such vacuum bubble 290. With the occurrence of the vacuum bubble 290, the pressure drops from a first level Pn (about ambient pressure) to a second level Pv (which in the example shown here is below zero bar, thus representing a “vacuum”). Until about a point in time t1, the pressure sensor 240 senses below second level Pv, and the pressure then “returns” to a higher pressure level at about Pn. In the example shown in FIG. 3, the pressure after t1 assumes a pressure level P1 slightly lower than the first level Pn.

A period of time Delta t between t1 and t0 can be assumed as the time when the vacuum bubble 290 (generated substantially at t0) exists, i.e. the time from generating the vacuum bubble 290 until being (re-)filled with liquid. Further, the period of time Delta t represents a measure for the flow resistance provided in the liquid network 200 against (substantially immediately) (re-)filling the vacuum bubble 290. Accordingly, a greater value of Delta t represents a higher flow resistance, and vice versa.

Under the assumption that all elements in the liquid network 200 except the fluidic element 220 remain substantially unchanged (with respect to the individual flow resistances), an increase in Delta t (e.g. determined in subsequent measurements) indicates an increase in the flow resistance provided by the fluidic element 220. When the flow resistance provided by the fluidic element 220 reaches a given threshold value, the fluidic element 220 can be assumed as providing a restriction in the liquid network 200, which may be caused by clogging. This provides a qualitative analysis for the existence of a restriction in the liquid network 200.

An actual quantitative value of the flow resistance causing the determined Delta t in the liquid network 200 can be derived from the value of Delta t, for example by using the following equations:

$$DeltaP = Pn - Pv$$

$$Flow = Removed Volume / Delta t$$

$$Restriction = DeltaP / Flow$$

With the values for “Removed Volume” and “Delta t” being typically known or determined, the value of “Flow” can be calculated. With the value of Pressure difference over Restriction (DeltaP) being known via

$$DeltaP = Pressure Pn - Pressure Pv$$

a value of “Restriction” can be calculated via DeltaP/Flow.

It is clear that additional sensors or information sources may be engaged to measure or estimate the Pn and Pv, such as barometers or barometric data provided via a data network and vapor pressure in the vacuum bubble measured in an optional extra step, comprising full blockage of the network in-and outlets to prevent any liquid supply and motion, or estimated from the knowledge of the composition and properties of the liquid comprised in the network.

In the example of FIGS. 2-3, an “unacceptable” restriction shall be assumed when Delta t reaches a given threshold, which may then trigger further actions, such as a communication (e.g. provided by the control unit 70) to a user of the liquid network 200 e.g. to check and clean or replace the filter 220 (or any other part that may get clogged or present an unwanted restriction) in order to remove or at least reduce the restriction.

The aforedescribed testing method to determine a restriction in the liquid network 200 can be (repeatedly) carried out e.g. from time to time. Monitoring and comparing the course of the value Delta t for each testing method carried out allows to determine a variation of the flow resistance in the liquid network 200 and thus of the existence of a restriction.

FIG. 4 illustrates in an example a repeated restriction testing in the liquid network 200, each time by generating a respective vacuum bubble 290 as described before. The abscissa denotes the respective test cycles (with 1 representing the first test cycle, and 6 representing the sixth and last test cycle), while the ordinate shows the period of time Delta t determined for each test cycle. In the example of FIG. 4, Delta t remains substantially constant and at a low value for the three first test cycles 1-3, and then start increasing from the fourth test cycle 4 onwards. At test cycle 6, the value of Delta t exceeds a threshold value TH indicating a restriction in the liquid network 200, and the control unit 70 will issue a corresponding notification that a restriction has been determined, preferably together with a proposal to clean or remove the filter 220 which might be clogged.

The test cycles shown in FIG. 4 are preferably carried out in a specific test mode wherein the blockage 260 is closed, e.g. controlled by the control unit 70, thus disabling liquid flow beyond the blockage 260. In normal mode of the liquid network 200 in FIG. 2, the blockage 260 is open, thus enabling liquid flow beyond the blockage 260 (i.e. towards the right side of the blockage 260 in the representation of FIG. 2).

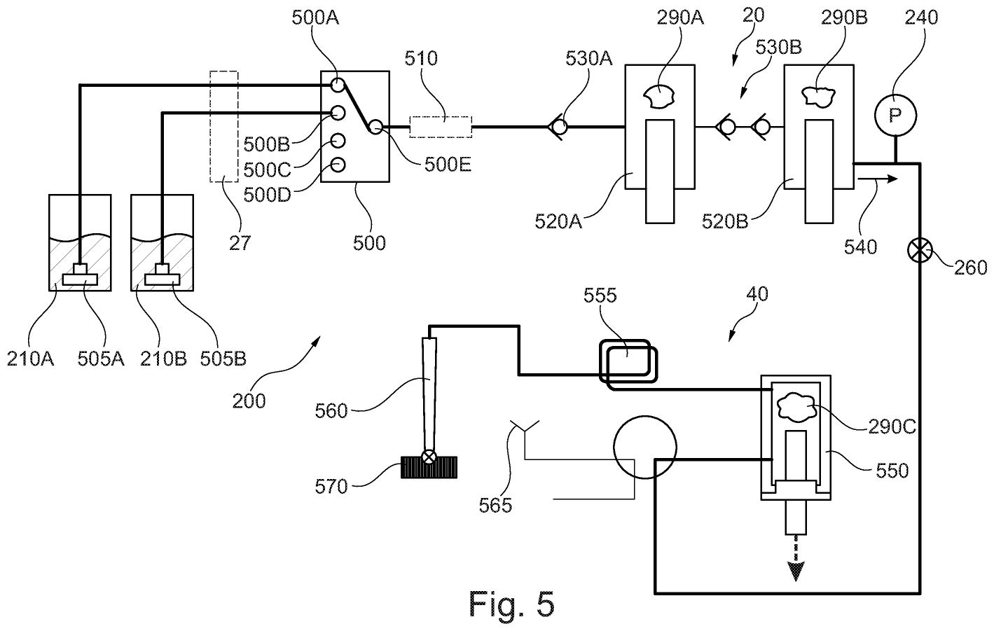

FIG. 5 illustrates a further exemplary embodiment of the liquid network 200. While the embodiment of FIG. 5 also comprises a liquid supply path similar as shown in FIG. 2, the embodiment of FIG. 5 is more complex and showing additional functionality and additional fluidic elements, in particular the functionality of the sample dispatcher 40 (as schematically shown in FIG. 1). However, it is to be understood that the embodiment shown in FIG. 5 shall only be schematically illustrating the solvent intake and solvent pumping functionality as well as the sample injection functionality depicted and described in FIG. 1. Accordingly, certain additional flow elements and flow paths as typically comprised in an HPLC setup have been omitted here for the sake of simplicity.

In the embodiment of FIG. 5, two liquid reservoirs 210A and 210B are provided and fluidically coupling (preferably via an optional degasser 27) to a multichannel valve 500, which can be a multichannel gradient valve (MCGV) as readily known in the art. The multichannel valve 500 provides a plurality (here: four) of input nodes 500A-500D and an output node 500E. The multichannel valve 500 allows to selectively switch one of the input nodes 500A-500D to the output node 500E, for example in an alternating manner in order to generate a solvent composition varying over time (e.g. in a gradient mode).

A respective solvent filter 505 is provided between each liquid reservoir 210 and the multichannel valve 500 in order to remove particles from the solvent (received from the liquid reservoir 210) before being drawn into the pump 20. In the embodiment of FIG. 5, a first solvent line immersed into the first liquid reservoir 210A is provided with a first solvent filter 505A, and a second solvent line immersed into the second liquid reservoir 210B is provided with a second solvent filter 505B.

An optional mixer 510 may be provided at the output node 500E and before the pump 20, which in the embodiment shown here shall be a binary serial pumping arrangement with two reciprocating pumps 520A and 520B arranged in a serial manner. The pump 20 typically comprises one or more valves 530 to generate a liquid flow in a desired flow direction, as readily known in the art. In the example here, an inlet valve 530A is provided at the inlet to the pump 20, namely between the multichannel valve 500 and the pump 20, and a double check valve 530B is provided between the reciprocating pumps 520A and 520B. A further valve may be provided at the outlet of the pump 20 but is omitted here for the sake of simplicity. By operation of the two reciprocating pumps 520A and 520B and in conjunction with the valves 530, the pump 20 allows to draw in fluid from the liquid reservoirs 210 and to provide a continuous supply of pressurised solvent at its outlet in the direction of the arrow 540, as well known in the art.

The pressure sensor 240 is coupled to the outlet of the pump 20 but may also be arranged and coupled at other positions within the flow path. A blockage 260 is also coupled downstream to the pump 20 allowing to disable the flow from the pump 20 in the direction of the arrow 540.

The sample dispatcher 40 is coupled downstream to the pump 20 and in the exemplary embodiment of FIG. 5 comprises a metering device 550, a sample loop 555, and a needle 560 which may be removed from a needle seat 565 and placed for example into a vial (not shown in FIG. 5) containing a sample fluid or into a blind seat 570 allowing to block the needle 560.

By operation of the metering device 550, the sample dispatcher 40 is configured to allow aspirating a sample fluid, for example when the needle 560 is removed from the needle seat 565 and e.g. immersed into a vial containing the sample fluid, and for transporting the aspirated sample fluid into the sample loop 555. The sample fluid contained in the sample loop 555 may then be introduced (for example injected) into the flow path between the pump 20 and the separating device 30 for chromatographically separating compounds of the sample fluid in the separating device 30.

In accordance with the aforedescribed, the fluidic network 200 in the embodiment of FIG. 5 allows determining restrictions in several different ways and at different locations within the fluidic network 200, dependent on the specific setup, in particular the respective valve configurations, provided blockages, and the location where the respective vacuum bubble 290 is generated. A few examples shall be given in the following.

Similar to what has been described with respect to FIG. 2, each of the reciprocating pumps 520A and 520B as well as the metering device 550 can be utilized to generate a respective vacuum bubble 290, either individually or even in a consecutive manner. In the schematic representation of FIG. 5, the reciprocating pump 520A may generate a vacuum bubble 290A, the reciprocating pump 520B may generate a vacuum bubble 290B, and/or the metering device 550 may generate a vacuum bubble 290C.

In a first example, only the first reciprocating pump 520A shall generate the vacuum bubble 290A. For this purpose, the blockage 260 shall be closed to disable flow out from the pump 20 (in the direction of arrow 540). Closing blockage 260 allows to stop backflow from the “rest of the liquid system” into the pump, such that the vacuum bubble is refilled over the to be detected restriction in the inlet path. Operation is as described with respect to FIG. 2, namely the pressure sensor 240 monitors the course of pressure over time, and on generation of the vacuum bubble 290A, as indicated by a sudden pressure drop (similar as shown in FIG. 3 at t0), a value of the period of time Delta t is determined until the pressure drop has vanished (similar as shown at t1 in FIG. 3) and accordingly the vacuum bubble 290A is assumed to be (re-)filled. This allows determining a restriction in the flow path between the solvent reservoirs 210 and the first reciprocating pump 520A, for example at the respective solvent filter 505 fluidically coupled via the multichannel valve 500 to the pump 20.

In a second example, the setup is the same as in the first example, however, with the difference that the second reciprocating pump 520B (instead of the first reciprocating pump 520A) is generating a respective vacuum bubble 290B. This allows determining a restriction in the flow path between the solvent reservoirs 210 and the second reciprocating pump 520B. Accordingly, with respect to the first example, also a restriction between the first and second reciprocating pumps 520A and 520B can be determined, for example at the respective solvent filter 505 fluidically coupled via the multichannel valve 500 to the pump 20.

In a third example, only the metering device 550 shall generate a respective vacuum bubble 290C. For this purpose, the blockage 260 shall be closed (as in the first and second examples) and in addition to this, a flow blockage shall also be provided at the needle 560. Such flow blockage at the needle 560 shall be accomplished in the third example by placing the needle 560 into the blind seat 570 (as depicted in FIG. 5). On generation of the vacuum bubble 290C, the course of pressure is monitored over time (e.g. by an additional pressure sensor not shown in FIG. 5), and the period of time Delta t is determined until the pressure drop (on generation of the vacuum bubble 290C) has vanished. This allows determining a restriction in a flow path between the metering device 550 and the needle 560.

In a fourth example similar to the third example, the needle 560 (instead of being placed into the blind seat 570) is immersed into a liquid containing container, such as a vial, not shown in FIG. 5. While the operation is substantially the same as in the third example, liquid from the container can be drawn in in order to (re-)fill the vacuum bubble 290C.

Similar to the aforedescribed examples, also plural vacuum bubbles 290 may be generated simultaneously or subsequently in order to determine restrictions.

Instead of the parameter pressure used for determining the period of time Delta t, other parameters such as a flow rate of the liquid can be applied accordingly.

In one embodiment, e.g. similar or in accordance to FIG. 5, the needle 560 is placed into a liquid volume, for example the needle 560 is immersed into a vial (for example containing a liquid sample). The sampler 40 is in a mainpass configuration (i.e. the pump 20 is directly coupled to the column in the separating device 30), nodes 500A-500D are closed, blockage 260 is open, and the vacuum bubble is generated in pump 520B. That way, it is possible to determine a restriction of the needle 560 and/or the sample loop 555.

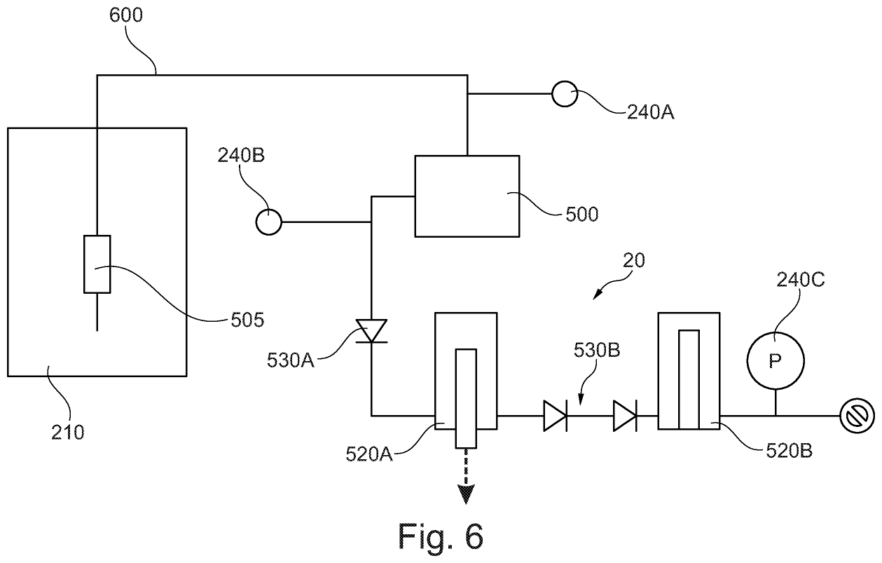

FIG. 6 describes another embodiment and examples for detection of restrictions, such as a blocked filter 505. The schematic embodiment of FIG. 6 is substantially similar to the embodiment shown in FIGS. 2 and 5. One or more pressure sensors (e.g. pressure sensors 240A and 240B, as shown in FIG. 6) may be applied between the filter 505 (in the fluid line from the solvent supply 210) and the first pump 520A. This typically means the sensor 240 has to measure substantially ambient pressure levels in the range of −1 . . . 0.5 bar. In this pressure level region, solvent resistant low-pressure sensors 240 can be fairly expensive, and also the signal-to noise ratio regarding the expected pressure drop due to the blocked filter can be quite low. However, rather than applying the (low pressure) pressure sensor(s) 240A and 240B in the input line upstream to the pump 20, a (high-pressure) pressure sensor 240C provided downstream to the pump 20 can be used.

There are several methods for generating amplified pressure signals in the solvent inlet path (to the pump 20) to a pressure range exceeding the range of −1 . . . 0.5 bar, whereas the amplified pressure signal can be representative of a flow restriction for example in the inlet filter 505.

In a first method for determining/detecting a restriction blockage, such as a blocked frit in the filter 505, a so-called transient measurement is provided by generating a pressure pulse signal by abruptly stopping a high flow intake stroke of the pump 20.

In an example, the inertia of the accelerated fluid and the damping properties of a blocked frit are exploited:
Move to Waste position with a multipurpose valve.
Move both pistons of the pumps 520A and 520B to the minimum volume position.
Wait a little bit for pressures to equalize.
Move the multipurpose valve to Blocked position.
Open the channel of the multichannel valve 500 (e.g. for water) and keep open.
Generate a flow in a feedline 600 (between the multichannel valve 500 and the solvent reservoir 210). Option A: Move the piston of pump 520A to the highest volume position as fast as possible and brake as fast as possible. Option B: Move both pumps 520A and 520B to the highest volume position as fast as possible to maximize flow in the feedline 600 and brake as fast as possible.
The moving fluid in the feedline 600 will continue to move and generate a pressure which can be seen on the pressure sensor 240C. In case of Option A, the outlet valve 530B may get opened by the differentials pressure.
Either the outlet 530B or the inlet 530A valve closes once the point of maximum pressure is passed, as the pressure in the feedline 600 or the piston of pump 520A drops below the pressure in the pump 520A or 520B.
The pressure reached should depend on the properties of the feedline 600 (such as flow resistance). Elasticity in the flow path can act as a buffer and reduce the effect (or render it non-linear).

In a second method for determining/detecting a restriction blockage, a pressure drop across the inlet filter of 505 is generated by a high flow intake stroke of the pump 520. A pressure-drop, caused e.g. by a blocked filter 505 is directly measured:
Move to Waste position with the multipurpose valve.
Move both pistons 520 to the minimum volume position.
Wait a little bit for pressures to equalize towards p0.
Move the multipurpose valve to Blocked position.
Open the channel of valve 500 (e.g. for water) and keep it open during the whole process.
Do an intake: Pistons 520 do an intake at the same time; Inlet-Valve 530A is open. Volume flow of piston 520B is greater than volume flow of piston 520A; Outlet-valve 530B is open. Hence: pressure sensor 240C is linked to fluid-path, every valve 530 is open to the (blocked) filter 505.
Measure the pressure drop while doing the intake. As both pistons 520 are operated, the pressure drop is delta_pressure˜volume_speed²˜(v_piston1+v_piston2)² and therefore amplified compared to normal operation (v_piston1). As the pressure drop is higher, it can be measured easily with a sensor 240C after piston 520B. Additional hydraulic capacities can be disregarded in this calculation as the pressure is measured when the static flow condition sufficiently applies.

$$Curve describing v\_speed \& pressure drop : pressure\_drop = p 02 + c {1}^{*} v\_speed + c {2}^{*} {v\_speed}^{2} ( + c {3}^{*} {v\_speed}^{3} ) .$$

From the constants p01, p02 and c1, c2, (c3) derivations in restriction over time can be parametrically tracked.

It will be understood that one or more of the processes, sub-processes, and process steps described herein may be performed by hardware, firmware, software, or a combination of two or more of the foregoing, on one or more electronic or digitally-controlled devices. The software may reside in a software memory (not shown) in a suitable electronic processing component or system such as, for example, the system controller 70 schematically depicted in FIG. 1. The software memory may include an ordered listing of executable instructions for implementing logical functions (that is, “logic” that may be implemented in digital form such as digital circuitry or source code, or in analog form such as an analog source such as an analog electrical, sound, or video signal). The instructions may be executed within a processing module, which includes, for example, one or more microprocessors, general purpose processors, combinations of processors, digital signal processors (DSPs), application specific integrated circuits (ASICs), field-programmable gate array (FPGAs), etc. Further, the schematic diagrams describe a logical division of functions having physical (hardware and/or software) implementations that are not limited by architecture or the physical layout of the functions. The examples of systems described herein may be implemented in a variety of configurations and operate as hardware/software components in a single hardware/software unit, or in separate hardware/software units.

The executable instructions may be implemented as a computer program product having instructions stored therein which, when executed by a processing module of an electronic system (e.g., the system controller 70 schematically depicted in FIG. 1), direct the electronic system to carry out the instructions. The computer program product may be selectively embodied in any non-transitory computer-readable storage medium for use by or in connection with an instruction execution system, apparatus, or device, such as an electronic computer-based system, processor-containing system, or other system that may selectively fetch the instructions from the instruction execution system, apparatus, or device and execute the instructions. In the context of this disclosure, a computer-readable storage medium is any non-transitory means that may store the program for use by or in connection with the instruction execution system, apparatus, or device. The non-transitory computer-readable storage medium may selectively be, for example, an electronic, magnetic, optical, electromagnetic, infrared, or semiconductor system, apparatus, or device. A non-exhaustive list of more specific examples of non-transitory computer readable media include: an electrical connection having one or more wires (electronic); a portable computer diskette (magnetic); a random access memory (electronic); a read-only memory (electronic); an erasable programmable read only memory such as, for example, flash memory (electronic); a compact disc memory such as, for example, CD-ROM, CD-R, CD-RW (optical); and digital versatile disc memory, i.e., DVD (optical). Note that the non-transitory computer-readable storage medium may even be paper or another suitable medium upon which the program is printed, as the program may be electronically captured via, for instance, optical scanning of the paper or other medium, then compiled, interpreted, or otherwise processed in a suitable manner if necessary, and then stored in a computer memory or machine memory.

1. A control unit for determining a restriction in a liquid network containing a liquid, the control unit being configured for:
invoke generating a vacuum bubble within the liquid network, wherein the vacuum bubble representing a volume wherein the liquid has been substantially removed,
determining a period of time between generating the vacuum bubble and until the volume has been substantially filled with the liquid, and
concluding on the restriction based on the determined period of time.

2. The control unit of claim 1, comprising at least one of:
the vacuum bubble is substantially free of the liquid and gases, preferably except gaseous components of the liquid;
generating the vacuum bubble comprises generating the vacuum bubble in a part of the liquid network coupled to one side of the restriction, while preferably the liquid network is configured to allow the liquid to flow from a part of the liquid network coupled to the opposing side of the restriction through the restriction and to fill the vacuum bubble.

3. The control unit of claim 1, comprising at least one of:
generating the vacuum bubble comprises abruptly increasing a volume of the liquid network, preferably faster than such increased volume is refilled by the liquid;
generating the vacuum bubble comprises pulling a piston, preferably abruptly pulling the piston, wherein the piston increases a volume of the liquid network, preferably faster than such increased volume is filled by the liquid.

4. The control unit of claim 1, comprising at least one of:
determining the period of time comprises monitoring a value of a parameter, preferably a pressure, in the liquid being in fluidic connection to the vacuum bubble, preferably in proximity to the vacuum bubble;
determining the period of time comprises determining a variation of a value of a parameter, preferably a pressure, of the liquid upon generation of the vacuum bubble, and determining the period of time until the parameter has substantially reached a value before generation of the vacuum bubble;
the period of time is determined between a first point in time when a value of a parameter, preferably a pressure, varies caused upon generation of the vacuum bubble, and a second point in time when the value of the parameter of the liquid has substantially reached a value before generation of the vacuum bubble;
the period of time is determined between a first point in time, when the action, preferably the piston withdrawal, was invoked or executed to generate the vacuum bubble, and a second point in time when the value of the parameter of the liquid has substantially reached a value before generation of the vacuum bubble;
the period of time is determined between a first point in time, and a second point in time, whereas at least one of the said points is characterized by rapid change of the value of the parameter of the liquid, wherein the rapid change is preferably determined by exceeding of a pre-set or dynamically determined threshold value by the time derivative of the said parameter, and/or the rapid change of a parameter value is preferably determined by known peak detector algorithms applied to the said parameter value or its derivative over time;
the period of time is determined between a first point in time when an underpressure in the liquid occurs upon generation of the vacuum bubble, and a second point in time when the underpressure has substantially been removed or equilibrated.

5. The control unit of claim 4, wherein the parameter is at least one of:
a pressure;
a flow, preferably a flow rate;
a density;
a temperature;
a force acting on a piston having generated the vacuum bubble;
a parameter suitable to determine whether there is at least one of a pressure difference or a flow over the restriction.

6. The control unit of claim 1, comprising at least one of:
concluding on the restriction comprises determining a value of restriction representing a quantitative value of the restriction in the liquid network;
concluding on the restriction comprises determining a qualitative information whether the restriction has increased or decreased, preferably by comparing with a reference, preferably previously determined for the restriction;
concluding on the restriction comprises adjustment of the determined restriction value by known or assumed liquid viscosity;
concluding on the hardware alterations in the liquid network based on the determined restriction value adjusted of by known or assumed liquid viscosity;
deriving user notification or corrective action on the instrument based on the determined restriction value.

7. The control unit of claim 1, comprising at least one of:
the liquid network is configured so that upon generation of the vacuum bubble, liquid from within the liquid network can flow through the restriction, and liquid from within the liquid network can flow to fill the vacuum bubble;
the liquid network is configured so that on one side of the restriction the vacuum bubble can be generated, while upon generation of the vacuum bubble liquid can flow from an opposing side of the restriction through the restriction;
the liquid network is configured so that on one side of the restriction the vacuum bubble can be generated, while upon generation of the vacuum bubble a pressure of the liquid on the opposing side of the restriction is higher than a pressure of the liquid where the vacuum bubble has been generated.

8. A liquid supply path comprising:
a liquid network containing a liquid and having a liquid drive, preferably a pumping system, configured for supplying the liquid at an outlet of the liquid network, and
the control unit of claim 1 configured for determining a restriction in the liquid network.

9. The liquid supply path of claim 8, comprising at least one of:
the control unit (is configured for providing a blockage, so that a flow rate at the outlet is substantially zero;
the control unit is configured for controlling the liquid drive to generate the vacuum bubble.

10. The liquid supply path of claim 8, comprising at least one of:
a sensor configured for determining a value of a parameter of the liquid, preferably for determining a value of pressure of the liquid;
a source comprising the liquid.

11. A fluid separation system for separating compounds of a sample fluid in a mobile phase, the fluid separation system comprising:
a liquid supply path according to claim 1, wherein the liquid is the mobile phase and the liquid drive is a mobile phase drive, preferably a pumping system, configured to drive the mobile phase through the fluid separation system, and
a separation unit, preferably a chromatographic column, configured to separate compounds of the sample fluid in the mobile phase.

12. The fluid separation system of claim 11, further comprising at least one of:
a sample dispatcher configured to introduce the sample fluid into the mobile phase;
a detector configured to detect separated compounds of the sample fluid;
a collection unit configured to collect separated compounds of the sample fluid;
a data processing unit configured to process data received from the fluid separation system;
a degassing apparatus for degassing the mobile phase.

13. A method for determining a restriction in a liquid network containing a liquid, comprising:
generating a vacuum bubble within the liquid network, wherein the vacuum bubble representing a volume wherein the liquid has been substantially removed,
determining a period of time between generating the vacuum bubble and until the volume has been substantially filled with the liquid, and
concluding on the restriction based on the determined period of time.

14. A non-transitory computer-readable medium, comprising instructions stored thereon, that when executed on a processor, control or perform one or more of the steps of claim 13.
